(19) United States
(12) Patent Application Publication
(10) Pub. No.: US 2023/0112060 A1
(43) Pub. Date: Apr. 13, 2023

(54) INSTALLATION STRUCTURE OF ELECTRIC WIRE INTO CONNNECTOR

(71) Applicants: TOYOTA JIDOSHA KABUSHIKI KAISHA, London (GB); Sumitomo Wiring Systems, Ltd., Yokkaichi-shi (JP)

(72) Inventors: Shoichi MINAMI, Chiryu-shi (JP); Masaaki KOBAYASHI, Yokkaichi-shi (JP)

(73) Assignees: TOYOTA JIDOSHA KABUSHIKI KAISHA, London (GB); Sumitomo Wiring Systems, Ltd., Yokkaichi-shi (JP)

(21) Appl. No.: 17/904,050

(22) PCT Filed: Feb. 18, 2021
(86) PCT No.: PCT/IB2021/000061

§ 371 Date: Aug. 11, 2022

(30) Foreign Application Priority Data
Feb. 26, 2020 (JP) 2020-030961

(51) Int. Cl. H01R 13/52; H01R 13/58; H01R 13/436; H01R 11/12

(52) U.S. Cl. CPC H01R 13/5208; H01R 11/12; H01R 13/4367; H01R 13/5812; H01R 2201/26

(57) ABSTRACT

In a structure in which a cable is installed into a connector is provided. A back retainer is arranged in a compressed state between an inner circumferential surface of a cylindrical portion, included in a connector body and extending in the axis line direction, and an outer circumferential surface of the cable. The back retainer includes a main annular portion which is configured such that a compression amount on the back retainer in the radial direction centered on the axis line direction gradually increases as the compression amount goes from one side toward the other side. The back retainer includes an engaging protrusion configured to prevent the back retainer from detaching from the cylindrical portion on an outer circumferential surface of the back retainer.

### BACKGROUND OF THE INVENTION

### 1. Field of the Invention

The present invention relates to an installation structure of an electric wire having a front end to which a terminal fitting is crimped into a connector.

### 2. Description of Related Art

In an installation structure of an electric wire into a connector, a structure in which an electric wire for vehicles is installed into the connector is well-known. In the structure, the electric wire having a front end to which a terminal fitting is crimped is installed into the connector via a sealing member (a rubber stopper), and the sealing member is prevented from detaching therefrom by a back retainer. For example, such a structure is disclosed in Japanese Unexamined Patent Application Publication No. 2015-15141 (JP 2015-15141 A).

### SUMMARY OF THE INVENTION

In the installation structure of an electric wire for vehicles into a connector described in JP 2015-15141 A, when the electric wire extending to the outside of the connector vibrates due to an external force (for example, vehicle vibration) or the like, the vibration is transferred to a part interpolated in the connector in the electric wire, and the reliability of connection inside the connector may be reduced.

The present invention provides an installation structure of an electric wire into a connector, which can prevent a reduction in the reliability of connection inside the connector even when the electric wire extending to the outside of the connector vibrates due to an external force or the like.

An installation structure of an electric wire into a connector according to one aspect of the present invention includes a connector body including a cylindrical portion that extends in one direction, an electric wire of which a front end on one side in the one direction is connected to a terminal fitting and the front end is interpolated in the connector body, a sealing member that abuts on an inner circumferential surface of the cylindrical portion and an outer circumferential surface of the electric wire, and a back retainer arranged between the inner circumferential surface of the cylindrical portion and the outer circumferential surface of the electric wire on the opposite side to the side of the front end ahead of the sealing member. The back retainer is arranged in a compressed state between the inner circumferential surface of the cylindrical portion and the outer circumferential surface of the electric wire. The back retainer includes a compression portion which is configured such that a compression amount on the back retainer in the radial direction of the cylindrical portion that extends in the one direction gradually increases as it goes from the side of the front end toward the opposite side. The back retainer includes a retaining portion configured to prevent the back retainer from detaching from the cylindrical portion on an outer circumferential surface of the back retainer.

In the above aspect, in a cross-section along the one direction, an outer circumferential surface of the compression portion before being press-fitted may have an inclination greater than an inclination of the inner circumferential surface of the cylindrical portion corresponding to a position at which the compression portion is press-fitted.

In the above aspect, the retaining portion may be arranged on the outer circumferential surface of the compression portion.

In the above aspect, the retaining portion may be an engaging protrusion protruding in the radial direction from the outer circumferential surface of the back retainer such that the retaining portion is engaged with an engaging hole formed in the cylindrical portion and penetrating the cylindrical portion in the radial direction.

In the above aspect, the back retainer may include a cylindrical extension portion extending from the compression portion to at least one of the side of the front end and the opposite side in the one direction. The cylindrical extension portion may include a region in which an outer circumferential surface of the cylindrical extension portion does not abut on the inner circumferential surface of the cylindrical portion and an inner circumferential surface of the cylindrical extension portion abuts on the outer circumferential surface of the electric wire.

With the installation structure of the electric wire into the connector according to the above aspect, (a) the back retainer is press-fitted between the inner circumferential surface of the cylindrical portion and the outer circumferential surface of the electric wire, (b) the back retainer includes the compression portion which is configured such that the compression amount on the back retainer in the radial direction of the cylindrical portion that extends in the one direction gradually increases as it goes from the front end side toward the opposite side, and (c) the outer circumferential surface of the back retainer is provided with the retaining portion configured to prevent the back retainer from detaching from the cylindrical portion. The compressed compression portion is press-fitted between the inner circumferential surface of the cylindrical portion and the outer circumferential surface of the electric wire, such that a pressing force from the back retainer side toward the electric wire side is generated on an abutting surface between the inner circumferential surface of the back retainer and the outer circumferential surface of the electric wire. As such, the electric wire is held in the connector body via the back retainer. For this reason, even when the electric wire extending to the outside of the connector body vibrates due to an external force or the like, the vibration on the abutting surface is prevented, such that the vibration is prevented from being transferred to a part interpolated in the connector in the electric wire. Therefore, a reduction in the reliability of connection inside the connector is prevented.

With the above configuration, in the cross-section along the one direction, the outer circumferential surface of the compression portion before being press-fitted has the inclination greater than the inclination of the inner circumferential surface of the cylindrical portion corresponding to the position at which the compression portion is press-fitted. When the compression portion of the back retainer is press-fitted in the cylindrical portion of the connector body, resistance that the compression portion receives from the cylindrical portion gradually increases from a low state to a high state as the compression portion is press-fitted. For this reason, it is easy to assemble the back retainer and the cylindrical portion of the connector body by press-fitting the former and the latter.

With the above configuration, the retaining portion is provided on the outer circumferential surface of the compression portion. The length of the back retainer in the one direction can become shorter when the retaining portion is provided on the outer circumferential surface of the compression portion than when the retaining portion is provided on the outer circumferential surface of a part other than the compression portion in the back retainer.

With the above configuration, the retaining portion is the engaging protrusion protruding in the radial direction from the outer circumferential surface of the back retainer such that the retaining portion is engaged with an engaging hole formed in the cylindrical portion and penetrating the cylindrical portion in the radial direction. As such, since the retaining portion is the engaging protrusion engaged with the engaging hole formed in the cylindrical portion and penetrating the cylindrical portion in the radial direction, it is easy to check whether the engaging protrusion which is the retaining portion is engaged with the engaging hole from the outside of the cylindrical portion. In other words, it can be easy to check whether the back retainer is prevented from detaching from the cylindrical portion.

With the above configuration, (a) the back retainer includes the cylindrical extension portion extending from the compression portion to at least one of the front end side and the opposite side in the one direction and (b) the cylindrical extension portion includes the region in which the outer circumferential surface of the cylindrical extension portion does not abut on the inner circumferential surface of the cylindrical portion and the inner circumferential surface of the cylindrical extension portion abuts on the outer circumferential surface of the electric wire. By providing the back retainer with the cylindrical extension portion, a pressing force from the back retainer side toward the electric wire side is generated on an abutting surface between the inner circumferential surface of the back retainer and the outer circumferential surface of the electric wire in the cylindrical extension portion together with the compression portion. As a result, a holding force for holding the electric wire in the connector body via the back retainer is enhanced as compared with a case where the cylindrical extension portion is not provided. Therefore, when the electric wire extending to the outside of the connector body vibrates due to an external force or the like, the vibration on the abutting surface is further prevented, and thus the reduction in the reliability of connection inside the connector is further prevented.

### BRIEF DESCRIPTION OF THE DRAWINGS

Features, advantages, and technical and industrial significance of exemplary embodiments of the invention will be described below with reference to the accompanying drawings, in which like signs denote like elements, and wherein:

FIG. 1 is a cross-sectional view of an installation structure of a cable into a connector according to a first embodiment of the present invention;

FIG. 2 is a partially enlarged view of the cross-sectional view illustrated in FIG. 1 and is also a diagram for describing shapes of a back retainer before and after being press-fitted;

FIG. 3 is a cross-sectional view of an installation structure of a cable into a connector according to a second embodiment of the present invention and is a diagram for describing shapes of a back retainer before and after being press-fitted;

FIG. 4 is a cross-sectional view of an installation structure of a cable into a connector according to a third embodiment of the present invention and is a diagram for describing shapes of a back retainer before and after being press-fitted;

FIG. 5 is a cross-sectional view of an installation structure of a cable into a connector according to a fourth embodiment of the present invention; and

FIG. 6 is a cross-sectional view of an installation structure of a cable into a connector in the related art.

### DETAILED DESCRIPTION OF EMBODIMENTS

Hereinafter, embodiments of the present invention will be described in detail with reference to the drawings. In each of the embodiments of the present invention and the related art to be described below, the drawings are appropriately simplified or modified in order to facilitate understanding, and dimensional ratios, shapes, and the like of each portion are not necessarily drawn accurately. Further, in each of the embodiments of the present invention and the related art, parts different from those in the embodiments to be described precedently will be mainly described. Same reference signs will be given to the parts having substantially the same functions as those in the embodiments to be described precedently, and description thereof will be appropriately omitted.

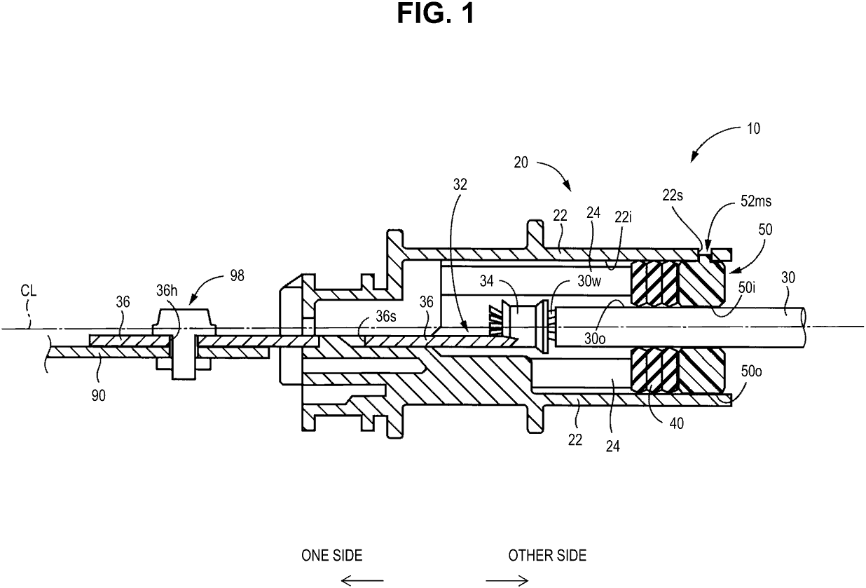

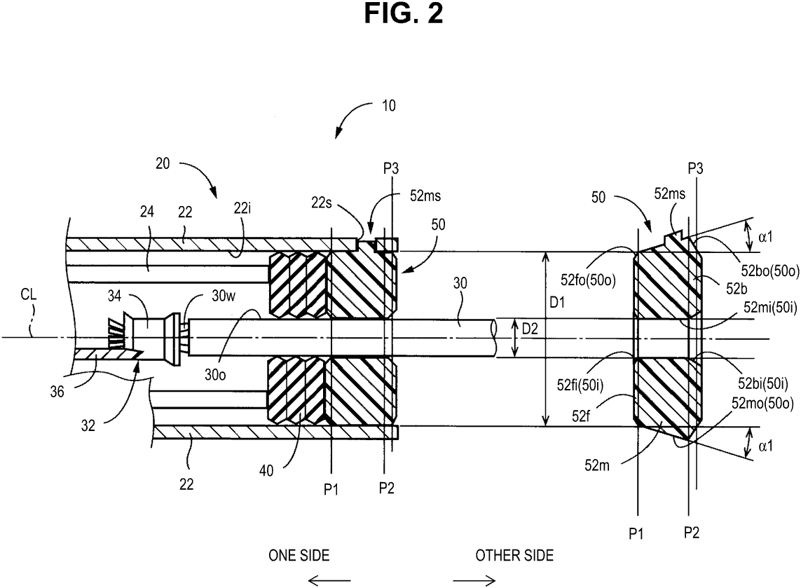

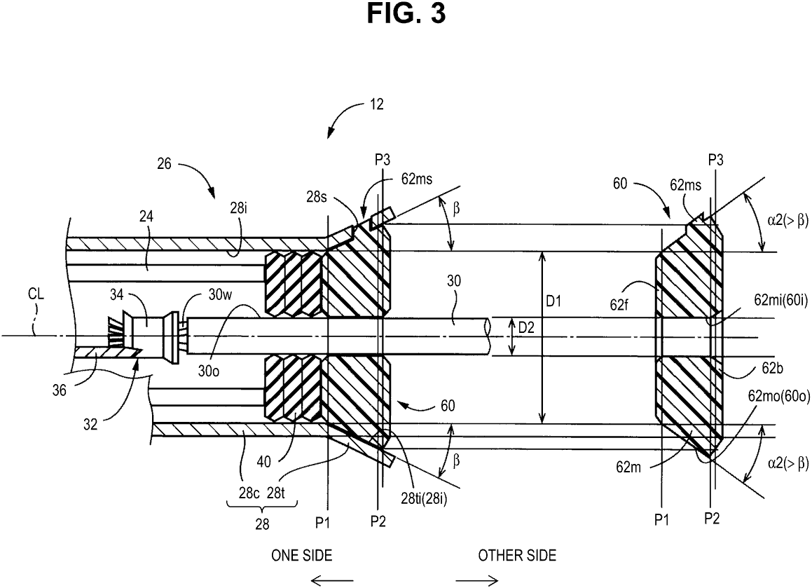

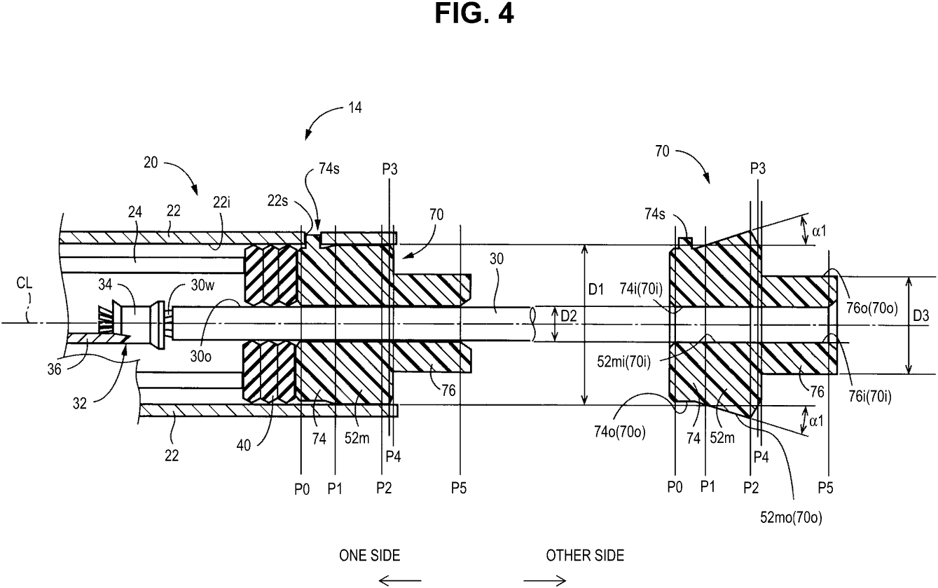

FIG. 1 is a cross-sectional view of an installation structure of a cable 30 into a connector 10 according to a first embodiment of the present invention. FIG. 2 is a partially enlarged view of the cross-sectional view illustrated in FIG. 1 and is also a diagram for describing shapes of a back retainer 50 before and after being press-fitted. In FIG. 2, the left side illustrates the shape of the back retainer 50 after the cable 30 and the back retainer 50 are installed into a connector body 20, and the right side illustrates the shape of the back retainer 50 before the cable 30 and the back retainer 50 are installed into the connector body 20. Both sides are cross-sectional views that include the axis line CL of a cylindrical portion 22 included in the connector body 20. Positions P0, P1, P2, P3, P4, P5 illustrated in each of FIG. 2, and FIGS. 3 and 4 to be described below represent the same positions in the axis line CL direction of each back retainer in the right and left drawings thereof, respectively, but they do not always represent the same positions in FIGS. 2, 3, and 4. Further, in the drawings on the left side of FIGS. 2 to 4, in order to facilitate understanding of the present invention, the back retainer is assumed to be compressed only in the radial direction centered on the axis line CL (hereinafter, simply referred to as the “radial direction”) by press-fitting (tight-fitting) the back retainer. However, strictly speaking, the back retainer can also be compressed in the axis line CL direction.

The connector 10 includes the connector body 20, the cable 30, a terminal fitting 32, a rubber stopper 40, and the back retainer 50. The installation structure of the cable 30 into the connector 10 corresponds to an “installation structure of an electric wire into a connector” in the present invention.

A material of the connector body 20 may be, for example, a synthetic resin. The connector body 20 includes the cylindrical portion 22 and a pressing portion 24. The cylindrical portion 22 has a cylindrical shape centered on the axis line CL and extends in the axis line CL direction. The cylindrical portion 22 and the axis line CL correspond to a “cylindrical portion” and a “straight line”, respectively, in the present invention.

An inner diameter of the cylindrical portion 22 is a diameter D1 [mm]. In the axis line CL direction, one side of the cylindrical portion 22 is connected to the inside of the connector body 20, and the other side of the cylindrical portion 22 is open toward the outside of the connector body 20. One side in the axis line CL direction (hereinafter, sometimes simply referred to as “one side”) corresponds to the “one side (the front end side)” in the present invention, and the other side in the axis line CL direction (hereinafter, sometimes simply referred to as “the other side”) corresponds to the “opposite side” in the present invention.

On the other side of the cylindrical portion 22, a plurality of engaging holes 22s penetrating the cylindrical portion 22 in the radial direction is provided at, for example, every predetermined equiangular interval (for example, every 2π/3 [rad]) in the circumferential direction. On the inner circumferential side of the cylindrical portion 22, a plurality of rod-shaped pressing portions 24 extending in the axis line CL direction is provided. In the axis line CL direction, the one side of each pressing portion 24 is fixed to the connector body 20, and the other side of each pressing portion 24 is configured to be capable of restricting the rubber stopper 40 from moving to the one side. The engaging hole 22s corresponds to an “engaging hole” in the present invention.

The cable 30 is an electric wire for vehicles, and may be, for example, an electric wire that supplies three-phase alternate current power for rotation drive to a three-phase synchronous rotating machine (a motor, not shown), which is a drive source for traveling. A conductive wire 30w of the cable 30 is coated with an insulated outer cover. For example, the cable 30 has a configuration in which an outer circumference of the conductive wire 30w, formed of a bundle of conductive metal wires, such as copper wires, is coated with a synthetic resin, and extends substantially in a columnar shape as a whole. An outer diameter of the cable 30 (that is, an outer diameter of an outer cover thereof) is a diameter D2 [mm]. An outer cover of a front end of the cable 30 (a part of the cable 30 on the one side in the axis line CL direction) is removed and a crimping portion 34 of the terminal fitting 32 to be described below is crimped to the front end thereof. The cable 30 corresponds to the “electric wire” in the present invention, and the front end of the cable 30 corresponds to a “front end” in the present invention.

The terminal fitting 32 is formed by, for example, pressing a plate-shaped conductive metal body, and includes the crimping portion 34 on the rear end side (the other side of the terminal fitting 32 in the axis line CL direction) and a plate-shaped terminal portion 36 having a predetermined width and extending from the crimping portion 34 to the front end side (the one side of the terminal fitting 32 in the axis line CL direction). The crimping portion 34 is a part to which the conductive wire 30w at the front end of the cable 30 is crimped and fixed. The terminal portion 36 is a part that is electrically connected to the crimping portion 34 and a bus bar 90 that is to be described below. A connecting hole 36h penetrating the terminal portion 36 in the thickness direction is provided on the front end side of the terminal portion 36, and an engaging hole 36s penetrating the terminal portion 36 in the thickness direction is provided between the connecting hole 36h and the crimping portion 34. The connecting hole 36h is used for fastening, by a fastening member 98, the terminal portion 36 to the plate-shaped bus bar 90 having a predetermined width, connected to a winding of a stator of the rotating machine, which is the above-described drive source for traveling, and extending to the other side in the axis line CL direction. The engaging hole 36s is used for preventing the terminal portion 36 from detaching therefrom in the rear end side direction (that is, the direction toward the opening side on the other side of the cylindrical portion 22). The connector body 20 is provided with an engaging protrusion at a position corresponding to a position of the engaging hole 36s.

The rubber stopper 40 is formed in an annular shape, and has an inner circumferential surface that abuts on an outer circumferential surface 30o of the cable 30 and an outer circumferential surface that abuts on an inner circumferential surface 22i of the cylindrical portion 22. The rubber stopper 40 has three pairs of inner and outer circumferential lips having lip shapes at ends thereof (tongue ends), respectively, in a cross-section including the axis line CL. The rubber stopper 40 is fitted in a state where it abuts on the inner circumferential surface 22i of the cylindrical portion 22 and the outer circumferential surface 30o of the cable 30 on the other side of the cylindrical portion 22 (between the crimping portion 34 and the opening of the cylindrical portion 22). The rubber stopper 40 is made of a material in which each of the inner and the outer circumferential lips is elastically deformed around the entire circumference, and can come into close contact with the inner circumferential surface 22i of the cylindrical portion 22 and the outer circumferential surface 30o of the cable 30. As such, waterproofness is ensured so as to prevent water from flowing from the outside to the inside of the connector body 20 through spaces between the inner circumferential surface 22i of the cylindrical portion 22 and the outer circumferential surface 30o of the cable 30. In the axis line CL direction, the rubber stopper 40 is restricted from moving to the front end side of the cable 30 by the pressing portion 24, and from moving to the rear end side, which is the other side of the cable 30, by the back retainer 50 to be described below. The rubber stopper 40 corresponds to a “sealing member” in the present invention.

Hereinbelow, the back retainer 50 before being press-fitted will be described based on the shape of the back retainer 50 before the cable 30 and the back retainer 50 are installed into the connector body 20, as illustrated on the right side of FIG. 2.

The shape of the back retainer 50 before the cable 30 and the back retainer 50 are installed into the connector body 20 is different from the shape thereof after the installation, that is, the back retainer 50 before being press-fitted is different from that after being press-fitted. For example, the back retainer 50 is divided into two parts in the axis line CL direction, and can be opened and closed, centered on a hinge portion. The back retainer 50 is made of a material having a high elastic modulus (that is, hard to be elastically deformed), such as a synthetic resin, as compared with the rubber stopper 40, and has an annular shape centered on the axis line CL. The back retainer 50 includes a main annular portion 52m, a front end annular portion 52f, and a rear end annular portion 52b.

The main annular portion 52m is a region between the position P1 and the position P2 in the axis line CL direction. The main annular portion 52m has substantially a cylindrical shape centered on the axis line CL and extends in the axis line CL direction. A cross-sectional area in the radial direction surrounded by an outer circumferential surface 52mo of the main annular portion 52m (an outer circumferential surface of the main annular portion 52m in an outer circumferential surface 50o of the back retainer 50) is greater than a cross-sectional area in the radial direction surrounded by the inner circumferential surface 22i of the cylindrical portion 22. Further, the main annular portion 52m has a shape in which the cross-sectional area in the radial direction surrounded by the outer circumferential surface 52mo of the main annular portion 52m increases as it goes from the one side toward the other side in the axis line CL direction. For example, a cross-section of the outer circumferential surface 52mo of the main annular portion 52m in the radial direction is circular-shaped, and an outer diameter of the main annular portion 52m is greater than the diameter D1 and gradually increases as it goes from the one side toward the other side in the axis line CL direction, that is, the diameter increases. In the cross-section including the axis line CL, the outer circumferential surface 52mo of the main annular portion 52m is inclined with respect to the axis line CL at an angle α1 [rad] (> 0). The inner diameter of the cylindrical portion 22 corresponding to a position at which the main annular portion 52m is press-fitted is constant with the diameter D1 as it goes from the one side toward the other side in the axis line CL direction. In other words, in the cross-section including the axis line CL, the inner circumferential surface 22i of the cylindrical portion 22 corresponding to the position at which the main annular portion 52m is press-fitted is inclined with respect to the axis line CL at an angle of 0 [rad]. Therefore, in the cross-section including the axis line CL, the outer circumferential surface 52mo of the main annular portion 52m before being press-fitted is inclined with respect to the axis line CL at an angle greater than that of the inner circumferential surface 22i of the cylindrical portion 22 corresponding to the position at which the main annular portion 52m is press-fitted.

An inner circumferential surface 52mi of the main annular portion 52m (an inner circumferential surface of the main annular portion 52m in an inner circumferential surface 50i of the back retainer 50) is configured such that the back retainer 50 can hold the cable 30 on the inner circumferential side thereof. For example, a cross-section of the inner circumferential surface 52mi of the main annular portion 52m in the radial direction is circular-shaped, and an inner diameter of the main annular portion 52m is constant with the diameter D2, which is the same value as the outer diameter of the cable 30.

The outer circumferential surface 52mo of the main annular portion 52m is provided with a plurality of engaging protrusions 52ms protruding in the radial direction as compared with the outer circumferential surface 52mo at, for example, every predetermined equiangular interval (for example, every 2π/3 [rad]) in the circumferential direction so that the engaging protrusions 52ms can be engaged with the engaging holes 22s provided on the cylindrical portion 22. The main annular portion 52m and the engaging protrusion 52ms correspond to a “compression portion” and a “retaining portion”, respectively, in the present invention.

The front end annular portion 52f is a region ahead of the position P1 toward the one side in the axis line CL direction. The front end annular portion 52f is a cylindrical-shaped part extending from the main annular portion 52m to the one side in the axis line CL direction. A cross-sectional area in the radial direction surrounded by an outer circumferential surface 52fo of the front end annular portion 52f (an outer circumferential surface of the front end annular portion 52f in the outer circumferential surface 50o of the back retainer 50) is smaller than a cross-sectional area in the radial direction surrounded by the inner circumferential surface 22i of the cylindrical portion 22. Further, the front end annular portion 52f has a shape in which the cross-sectional area in the radial direction surrounded by the outer circumferential surface 52fo of the front end annular portion 52f decreases as it goes from the other side toward the one side in the axis line CL direction. For example, a cross-section of the outer circumferential surface 52fo of the front end annular portion 52f in the radial direction is circular-shaped, and an outer diameter of the front end annular portion 52f is smaller than the diameter D1 and gradually decreases as it goes from the other side toward the one side in the axis line CL direction, that is, the diameter decreases. A cross-sectional area in the radial direction surrounded by an inner circumferential surface 52fi of the front end annular portion 52f (an inner circumferential surface of the front end annular portion 52f in the inner circumferential surface 50i of the back retainer 50) is greater than a cross-sectional area in the radial direction surrounded by the outer circumferential surface 30o of the cable 30. Further, the front end annular portion 52f has a shape in which the cross-sectional area in the radial direction surrounded by the inner circumferential surface 52fi of the front end annular portion 52f increases as it goes from the other side toward the one side in the axis line CL direction. For example, a cross-section of the inner circumferential surface 52fi of the front end annular portion 52f in the radial direction is circular-shaped, and an inner diameter of the front end annular portion 52f is greater than the diameter D2 and gradually increases as it goes from the other side toward the one side in the axis line CL direction, that is, the diameter increases.

The rear end annular portion 52b is a region ahead of the position P2 toward the other side in the axis line CL direction. The rear end annular portion 52b is a cylindrical-shaped part extending from the main annular portion 52m to the other side in the axis line CL direction. A cross-sectional area in the radial direction surrounded by an outer circumferential surface 52bo of the rear end annular portion 52b (an outer circumferential surface of the rear end annular portion 52b in the outer circumferential surface 50o of the back retainer 50) is smaller than a cross-sectional area in the radial direction surrounded by the outer circumferential surface 52mo at the rear end of the main annular portion 52m. Further, the rear end annular portion 52b has a shape in which the cross-sectional area in the radial direction surrounded by the outer circumferential surface 52bo of the rear end annular portion 52b decreases as it goes from the one side toward the other side in the axis line CL direction. For example, a cross-section of the outer circumferential surface 52bo of the rear end annular portion 52b in the radial direction is circular-shaped, and an outer diameter of the rear end annular portion 52b gradually decreases as it goes from the one side toward the other side in the axis line CL direction, that is, the diameter decreases. A cross-sectional area in the radial direction surrounded by an inner circumferential surface 52bi of the rear end annular portion 52b (an inner circumferential surface of the rear end annular portion 52b in the inner circumferential surface 50i of the back retainer 50) is greater than a cross-sectional area in the radial direction surrounded by the outer circumferential surface 30o of the cable 30. Further, the rear end annular portion 52b has a shape in which the cross-sectional area in the radial direction surrounded by the inner circumferential surface 52bi of the rear end annular portion 52b increases as it goes from the one side toward the other side in the axis line CL direction. For example, a cross-section of the inner circumferential surface 52bi of the rear end annular portion 52b in the radial direction is circular-shaped, and an inner diameter of the rear end annular portion 52b is greater than the diameter D2 and gradually increases as it goes from the one side toward the other side in the axis line CL direction, that is, the diameter increases.

Hereinbelow, the back retainer 50 after being press-fitted will be described based on a state where the cable 30 and the back retainer 50 are installed into the connector body 20, as illustrated on the left side of FIG. 2.

The cable 30 and the back retainer 50 are installed into the connector body 20 in the following manner. First, after the cable 30 having the front end to which the terminal fitting 32 is crimped is interpolated (inserted) from the opening on the other side of the cylindrical portion 22, the rubber stopper 40 is press-fitted from the opening of the cylindrical portion 22 into the inside of the cylindrical portion 22 while holding the cable 30 on the inner circumferential side thereof. Then, after the rubber stopper 40 is press-fitted, the back retainer 50 is press-fitted from the opening of the cylindrical portion 22 into the inside of the cylindrical portion 22 while holding the cable 30 on the inner circumferential side thereof. As described above, since the cross-sectional area in the radial direction surrounded by the outer circumferential surface 52mo of the main annular portion 52m is greater than the cross-sectional area in the radial direction surrounded by the inner circumferential surface 22i of the cylindrical portion 22, the back retainer 50 is press-fitted to be interpolated into the cylindrical portion 22. The back retainer 50 is press-fitted such that the front end annular portion 52f faces the rubber stopper 40. By press-fitting the back retainer 50, the engaging protrusion 52ms is engaged with the engaging hole 22s, such that the back retainer 50 is prevented from detaching from the cylindrical portion 22 and the back retainer 50 is fixed between the inner circumferential surface 22i of the cylindrical portion 22 and the outer circumferential surface 30o of the cable 30. The back retainer 50 is arranged ahead of the rubber stopper 40 toward the other side. As such, the one side of the rubber stopper 40 abuts on the other side of the pressing portion 24 and the other side of the rubber stopper 40 abuts on the one side of the back retainer 50, such that the rubber stopper 40 is restricted from moving to any of the one side and the other side.

The press-fitted back retainer 50 is in a compressed state in the radial direction by the cylindrical portion 22. Specifically, the main annular portion 52m is compressed such that the outer diameter thereof becomes the diameter D1. Further, in the rear end annular portion 52b, a region having an outer diameter greater than the diameter D1 (a region between the position P2 and the position P3 in the axis line CL direction) is also compressed such that the outer diameter thereof becomes the diameter D1. A compression amount on the main annular portion 52m in the radial direction is in a state where the compression amount gradually increases as it goes from the position P1 (the one side) toward the position P2 (the other side). A compression amount on the rear end annular portion 52b in the radial direction is in a state where the compression amount gradually decreases as it goes from the position P2 (the one side) toward the position P3 (the other side).

With the present embodiment, (a) the back retainer 50 is press-fitted between the inner circumferential surface 22i of the cylindrical portion 22 and the outer circumferential surface 30o of the cable 30, and (b) the back retainer 50 includes the main annular portion 52m by which the compression amount on the back retainer 50 in the radial direction is gradually increased as it goes from the one side toward the other side in the axis line CL direction, and (c) the outer circumferential surface 52mo of the main annular portion 52m of the back retainer 50 is provided with the engaging protrusion 52ms so as to prevent the back retainer 50 from detaching from the cylindrical portion 22. By press-fitting the compressed main annular portion 52m between the inner circumferential surface 22i of the cylindrical portion 22 and the outer circumferential surface 30o of the cable 30, a pressing force from the back retainer 50 side toward the cable 30 side is generated on an abutting surface between the inner circumferential surface 50i of the back retainer 50 and the outer circumferential surface 30o of the cable 30. As such, the cable 30 is held in the connector body 20 via the back retainer 50. For this reason, even when the cable 30 extending to the outside of the connector body 20 vibrates due to an external force or the like, the vibration on the above-described abutting surface is prevented, such that the vibration is prevented from being transferred to the crimping portion 34, which is a crimping portion between the cable 30 and the terminal fitting 32. Therefore, a reduction in connection strength of the crimping portion 34 is prevented. As a result, a reduction in the reliability of connection at the crimping portion 34 inside the connector 10 is prevented.

With the present embodiment, in the cross-section including the axis line CL, the outer circumferential surface 52mo of the main annular portion 52m before being press-fitted is inclined at an angle greater than that of the inner circumferential surface 22i of the cylindrical portion 22 corresponding to the position at which the main annular portion 52m is press-fitted. When the main annular portion 52m of the back retainer 50 is press-fitted in the cylindrical portion 22 of the connector body 20, resistance that the main annular portion 52m receives from the cylindrical portion 22 gradually increases from a low state to a high state as the main annular portion 52m is press-fitted. For this reason, it is easy to assemble the back retainer 50 and the cylindrical portion 22 of the connector body 20 by press-fitting the former and the latter.

With the present embodiment, the engaging protrusion 52ms is provided on the outer circumferential surface 52mo of the main annular portion 52m. The length of the back retainer 50 in the axis line CL direction can become shorter when the engaging protrusion 52ms is provided on the outer circumferential surface 52mo of the main annular portion 52m than when the engaging protrusion 52ms is provided on the outer circumferential surface 50o of a part other than the main annular portion 52m in the back retainer 50.

With the present embodiment, the engaging protrusion 52ms protrudes in the radial direction as compared with the outer circumferential surface 50o of the back retainer 50 so as to be engaged with the engaging hole 22s formed in the cylindrical portion 22 and penetrating the cylindrical portion 22 in the radial direction. As such, since the engaging protrusion 52ms is engaged with the engaging hole 22s formed in the cylindrical portion 22 and penetrating the cylindrical portion 22 in the radial direction, it is easy to check whether the engaging protrusion 52ms is engaged with the engaging hole 22s from the outside of the cylindrical portion 22. In other words, it can be easy to check whether the back retainer 50 is prevented from detaching from the cylindrical portion 22.

FIG. 3 is a cross-sectional view of an installation structure of the cable 30 into a connector 12 according to a second embodiment of the present invention and is a diagram for describing shapes of a back retainer 60 before and after being press-fitted. The present embodiment and the above-described first embodiment are substantially the same in terms of the configuration, but are different in that a connector body 26 and the back retainer 60 are used in the former, instead of the connector body 20 and the back retainer 50 that are used in the latter, respectively. In FIG. 3, the left side illustrates a state where the cable 30 and the back retainer 60 are installed into the connector body 26, and the right side illustrates the shape of the back retainer 60 before the cable 30 and the back retainer 60 are installed into the connector body 26. Both sides are cross-sectional views including the axis line CL of a cylindrical portion 28 to be described below and to be included in the connector body 26.

The connector 12 includes the connector body 26, the cable 30, the terminal fitting 32, the rubber stopper 40, and the back retainer 60. The installation structure of the cable 30 into the connector 12 corresponds to an “installation structure of the electric wire into the connector” in the present invention.

A shape of the connector body 26 is different from that of the connector body 20 in the first embodiment. The connector body 26 includes the cylindrical portion 28 and the pressing portion 24. The cylindrical portion 28 has substantially a cylindrical shape centered on the axis line CL, extends in the axis line CL direction, and includes a cylinder portion 28c and a tapered portion 28t. The cylindrical portion 28 and the axis line CL correspond to the “cylindrical portion” and the “straight line”, respectively, in the present invention.

In the cylindrical portion 28, the cylinder portion 28c is a region ahead of the position P1 toward the one side in the axis line CL direction and having an inner diameter constant with the diameter D1, and the tapered portion 28t is a region ahead of the position P1 toward the other side in the axis line CL direction and having the inner diameter that increases as it goes from the one side toward the other side. An inner circumferential surface 28i of the cylindrical portion 28 has a diameter constant with the diameter D1 in the cylinder portion 28c and a diameter increasing in the tapered portion 28t. The tapered portion 28t has a shape in which a cross-sectional area in the radial direction surrounded by an inner circumferential surface 28ti of the tapered portion 28t (an inner circumferential surface in the tapered portion 28t in the inner circumferential surface 28i of the cylindrical portion 28) increases as it goes from the one side to the other side in the axis line CL direction. For example, in the cross-section including the axis line CL, the inner circumferential surface 28ti of the tapered portion 28t is inclined with respect to the axis line CL at an angle β [rad] (> 0). The tapered portion 28t is provided with a plurality of engaging holes 28s penetrating the tapered portion 28t in the radial direction at, for example, every predetermined equiangular interval (for example, every 2π/3 [rad]) in the circumferential direction. The engaging hole 28s corresponds to the “engaging hole” in the present invention.

Hereinbelow, the back retainer 60 before being press-fitted will be described based on the shape of the back retainer 60 before the cable 30 and the back retainer 60 are installed into the connector body 26, as illustrated on the right side of FIG. 3.

The shape of the back retainer 60 before being press-fitted is different from that of the back retainer 50 before being press-fitted in the first embodiment. The back retainer 60 includes a main annular portion 62m, a front end annular portion 62f, and a rear end annular portion 62b.

The main annular portion 62m is a region between the position P1 and the position P2 in the axis line CL direction. The main annular portion 62m has substantially the same shape as the main annular portion 52m in the above-described first embodiment. However, they are different in that, for example, in a cross-section including the axis line CL, an outer circumferential surface 62mo of the main annular portion 62m (the outer circumferential surface of the main annular portion 62m in an outer circumferential surface 60o of the back retainer 60) is inclined with respect to the axis line CL at an angle α2 [rad] (> β). A cross-sectional area in the radial direction surrounded by the outer circumferential surface 62mo of the main annular portion 62m is greater than a cross-sectional area in the radial direction surrounded by the inner circumferential surface 28i of the cylindrical portion 28 (that is, the tapered portion 28t) corresponding to a position at which the main annular portion 62m is press-fitted. In the cross-section including the axis line CL, the inner circumferential surface 28i of the cylindrical portion 28 (that is, the tapered portion 28t) corresponding to the position at which the main annular portion 62m is press-fitted is inclined with respect to the axis line CL at the angle β. Therefore, in the cross-section including the axis line CL, the outer circumferential surface 62mo of the main annular portion 62m before being press-fitted is inclined with respect to the axis line CL at an angle greater than that of the inner circumferential surface 28i of the cylindrical portion 28 (that is, the tapered portion 28t) corresponding to the position at which the main annular portion 62m is press-fitted.

An inner circumferential surface 62mi of the main annular portion 62m (the inner circumferential surface of the main annular portion 62m in an inner circumferential surface 60i of the back retainer 60) is configured such that the back retainer 60 can hold the cable 30 on the inner circumferential side thereof. For example, a cross-section of the inner circumferential surface 62mi of the main annular portion 62m in the radial direction is circular-shaped, and an inner diameter of the main annular portion 62m is constant with the diameter D2 which is the same value as the outer diameter of the cable 30.

The outer circumferential surface 62mo of the main annular portion 62m is provided with a plurality of engaging protrusions 62ms protruding in the radial direction as compared with the outer circumferential surface 62mo at, for example, every predetermined equiangular interval (for example, every 2π/3 [rad]) in the circumferential direction so that the engaging protrusions 62ms can be engaged with the engaging holes 28s provided on the tapered portion 28t. The main annular portion 62m and the engaging protrusion 62ms correspond to a “compression portion” and a “retaining portion”, respectively, in the present invention.

The front end annular portion 62f is a region ahead of the position P1 toward the one side in the axis line CL direction. The front end annular portion 62f is a cylindrical-shaped part extending from the main annular portion 62m to the one side in the axis line CL direction. A shape of the front end annular portion 62f with respect to the main annular portion 62m is the same as that of the front end annular portion 52f with respect to the main annular portion 52m in the above-described first embodiment.

The rear end annular portion 62b is a region ahead of the position P2 toward the other side in the axis line CL direction. The rear end annular portion 62b is a cylindrical-shaped part extending from the main annular portion 62m to the other side in the axis line CL direction. A shape of the rear end annular portion 62b with respect to the main annular portion 62m is the same as that of the rear end annular portion 52b with respect to the main annular portion 52m in the first embodiment.

Hereinbelow, the back retainer 60 after being press-fitted will be described based on a state where the cable 30 and the back retainer 60 are installed into the connector body 26, as illustrated on the left side of FIG. 3.

The cable 30 and the back retainer 60 are installed into the connector body 26 in the same manner as in the above-described first embodiment. First, after the cable 30 having the front end to which the terminal fitting 32 is crimped is interpolated from the opening on the other side of the tapered portion 28t in the cylindrical portion 28, the rubber stopper 40 is press-fitted from the opening of the cylindrical portion 28 into the inside of the cylindrical portion 28 while holding the cable 30 on the inner circumferential side thereof. Then, after the rubber stopper 40 is press-fitted, the back retainer 60 is press-fitted from the opening of the cylindrical portion 28 into the inside of the cylindrical portion 28 while holding the cable 30 on the inner circumferential side thereof. As described above, since the cross-sectional area in the radial direction surrounded by the outer circumferential surface 62mo of the main annular portion 62m is greater than the cross-sectional area in the radial direction surrounded by the inner circumferential surface 28i of the cylindrical portion 28 (that is, the tapered portion 28t) corresponding to the position at which the main annular portion 62m is press-fitted, the back retainer 60 is press-fitted to be interpolated into the cylindrical portion 28. The back retainer 60 is press-fitted such that the front end annular portion 62f faces the rubber stopper 40. By press-fitting the back retainer 60, the engaging protrusion 62ms is engaged with the engaging hole 28s, such that the back retainer 60 is prevented from detaching from the cylindrical portion 28 and the back retainer 60 is fixed between the inner circumferential surface 28i of the cylindrical portion 28 and the outer circumferential surface 30o of the cable 30. The back retainer 60 is arranged ahead of the rubber stopper 40 toward the other side. As such, the one side of the rubber stopper 40 abuts on the other side of the pressing portion 24 and the other side of the rubber stopper 40 abuts on the one side of the back retainer 60, such that the rubber stopper 40 is restricted from moving to any of the one side and the other side.

The press-fitted back retainer 60 is in a state of being compressed in the radial direction by the tapered portion 28t in the cylindrical portion 28. Specifically, the main annular portion 62m is compressed such that the outer diameter thereof becomes a diameter corresponding to an inner diameter of the tapered portion 28t. Further, in the rear end annular portion 62b, a region having an outer diameter greater than the inner diameter of the tapered portion 28t (a region between the position P2 and the position P3 in the axis line CL direction) is also compressed such that the outer diameter thereof becomes a diameter corresponding to the inner diameter of the tapered portion 28t. A compression amount on the main annular portion 62m in the radial direction is in a state where the compression amount gradually increases as it goes from the position P1 (the one side) toward the position P2 (the other side). A compression amount on the rear end annular portion 62b in the radial direction is in a state where the compression amount gradually decreases as it goes from the position P2 (the one side) toward the position P3 (the other side).

With the present embodiment, (a) the back retainer 60 is press-fitted between the inner circumferential surface 28i of the cylindrical portion 28 and the outer circumferential surface 30o of the cable 30, (b) the back retainer 60 includes the main annular portion 62m by which the compression amount in the radial direction on the back retainer 60 is gradually increased as it goes from the one side toward the other side in the axis line CL direction, and (c) the outer circumferential surface 62mo of the main annular portion 62m of the back retainer 60 is provided with the engaging protrusion 62ms so as to prevent the back retainer 60 from detaching from the cylindrical portion 28. By press-fitting the compressed main annular portion 62m between the inner circumferential surface 28i of the cylindrical portion 28 and the outer circumferential surface 30o of the cable 30, a pressing force from the back retainer 60 side toward the cable 30 side is generated on an abutting surface between the inner circumferential surface 60i of the back retainer 60 and the outer circumferential surface 30o of the cable 30. As such, the cable 30 is held in the connector body 26 via the back retainer 60.

Further, in the cross-section including the axis line CL, the outer circumferential surface 62mo of the main annular portion 62m before being press-fitted is inclined with respect to the axis line CL at an angle greater than that of the inner circumferential surface 28i of the cylindrical portion 28 (that is, the tapered portion 28t) corresponding to the position at which the main annular portion 62m is press-fitted. When the main annular portion 62m of the back retainer 60 is press-fitted in the cylindrical portion 28 of the connector body 26, resistance that the main annular portion 62m receives from the cylindrical portion 28 gradually increases from a low state to a high state as the main annular portion 62m is press-fitted.

Further, the engaging protrusion 62ms is provided on the outer circumferential surface 62mo of the main annular portion 62m. The engaging protrusion 62ms protrudes in the radial direction as compared with the outer circumferential surface 60o of the back retainer 60 so as to be engaged with the engaging hole 28s formed in the cylindrical portion 28 and penetrating the cylindrical portion 28 in the radial direction.

Therefore, with the configurations in the present embodiment, the same effect as those in the above-described first embodiment is achieved.

FIG. 4 is a cross-sectional view of an installation structure of the cable 30 into a connector 14 according to a third embodiment of the present invention and is a diagram for describing shapes of a back retainer 70 before and after being press-fitted. The present embodiment and the above-described first embodiment are substantially the same in terms of the configurations, but are different in that the back retainer 70 is used in the former, instead of the back retainer 50 that is used in the latter. In FIG. 4, the left side illustrates a state where the cable 30 and the back retainer 70 are installed into a connector body 20, and the right side illustrates a shape of the back retainer 70 before the cable 30 and the back retainer 70 are installed into the connector body 20. Both sides are cross-sectional views including the axis line CL of the cylindrical portion 22 included in the connector body 20.

The connector 14 includes the connector body 20, the cable 30, the terminal fitting 32, the rubber stopper 40, and the back retainer 70. The installation structure of the cable 30 into the connector 14 corresponds to the “installation structure of the electric wire into the connector” in the present invention.

Hereinbelow, the back retainer 70 before being press-fitted will be described based on the shape of the back retainer 70 before the cable 30 and the back retainer 70 are installed into the connector body 20, as illustrated on the right side of FIG. 4.

The shape of the back retainer 70 before being press-fitted is different from that of the back retainer 50 before being press-fitted in the first embodiment. The back retainer 70 has a configuration in which a front end cylindrical extension portion 74 and a rear end cylindrical extension portion 76 are added to the main annular portion 52m of the back retainer 50 in the above-described first embodiment.

The main annular portion 52m is a region between the position P1 and the position P2 in the axis line CL direction.

The front end cylindrical extension portion 74 is a region ahead of the position P1 toward the one side in the axis line CL direction. The front end cylindrical extension portion 74 is a cylindrical part extending from the main annular portion 52m to the one side in the axis line CL direction. A cross-sectional area in the radial direction surrounded by an outer circumferential surface 74o of the front end cylindrical extension portion 74 (an outer circumferential surface of the front end cylindrical extension portion 74 in an outer circumferential surface 70o of the back retainer 70) is smaller than the cross-sectional area in the radial direction surrounded by the inner circumferential surface 22i of the cylindrical portion 22. Further, the front end cylindrical extension portion 74 has a shape having a region in which the cross-sectional area in the radial direction surrounded by the outer circumferential surface 74o of the front end cylindrical extension portion 74 gradually decreases as it goes away from the main annular portion 52m on the other side adjacent to the main annular portion 52m in the axis line CL direction, a region in which the cross-sectional area is constant as it goes further away from the main annular portion 52m, and a region in which the cross-sectional area gradually decreases as it goes away from the main annular portion 52m at the front end on the one side of the front end cylindrical extension portion 74. For example, a cross-section of the outer circumferential surface 74o of the front end cylindrical extension portion 74 in the radial direction is circular-shaped, and the outer diameter of the front end cylindrical extension portion 74 is smaller than the diameter D1. The outer diameter of the front end cylindrical extension portion 74 gradually decreases on the main annular portion 52m side of the front end cylindrical extension portion 74, as it goes away from the main annular portion 52m, is constant as it goes further away from the main annular portion 52m, and gradually decreases at the front end of the front end cylindrical extension portion 74 as it goes away from the main annular portion 52m. The front end cylindrical extension portion 74 has a shape having a region in which the cross-sectional area in the radial direction surrounded by an inner circumferential surface 74i of the front end cylindrical extension portion 74 (an inner circumferential surface of the front end cylindrical extension portion 74 in an inner circumferential surface 70i of the back retainer 70) is the same as the cross-sectional area in the radial direction surrounded by the outer circumferential surface 30o of the cable 30 on the other side adjacent to the main annular portion 52m and a region in which the cross-sectional area increases at the front end of the front end cylindrical extension portion 74 as it goes away from the main annular portion 52m. For example, a cross-section of the inner circumferential surface 74i of the front end cylindrical extension portion 74 in the radial direction is circular-shaped. An inner diameter of the front end cylindrical extension portion 74 is constant with the diameter D2 on the other side adjacent to the main annular portion 52m and gradually increases from the diameter D2 at the front end of the front end cylindrical extension portion 74 as it goes away from the main annular portion 52m.

The outer circumferential surface 74o of the front end cylindrical extension portion 74 is provided with a plurality of engaging protrusions 74s protruding in the radial direction as compared with the diameter D1 at, for example, every predetermined equiangular interval (for example, every 2π/3 [rad]) in the circumferential direction so that the engaging protrusions 74s can be engaged with the engaging holes 22s provided on the cylindrical portion 22. The front end cylindrical extension portion 74 and the engaging protrusions 74s correspond to a “cylindrical extension portion” and a “retaining portion”, respectively, in the present invention.

The rear end cylindrical extension portion 76 is a region ahead of the position P2 toward the other side in the axis line CL direction. The rear end cylindrical extension portion 76 is a cylindrical part extending from the main annular portion 52m to the other side in the axis line CL direction. A cross-sectional area in the radial direction surrounded by an outer circumferential surface 76o of the rear end cylindrical extension portion 76 (an outer circumferential surface of the rear end cylindrical extension portion 76 in the outer circumferential surface 70o of the back retainer 70) is smaller than the cross-sectional area in the radial direction surrounded by the outer circumferential surface 52mo of the front end in the main annular portion 52m. Further, the rear end cylindrical extension portion 76 has a shape having a region in which the cross-sectional area in the radial direction surrounded by the outer circumferential surface 76o of the rear end cylindrical extension portion 76 gradually decreases as it goes away from the main annular portion 52m on the other side adjacent to the main annular portion 52m in the axis line CL direction, and a region in which the cross-sectional area is constant as it goes further away from the main annular portion 52m. For example, a cross-section of the outer circumferential surface 76o of the rear end cylindrical extension portion 76 in the radial direction is circular-shaped, and the outer diameter of the rear end cylindrical extension portion 76 gradually decreases between the position P2 and the position P4 in the axis line CL direction as it goes away from the main annular portion 52m, becomes the diameter D3 [mm] (D2 < D3 < D1) smaller than the diameter D1 at the position P4 in the axis line CL direction, and is constant with the diameter D3 at a position farther from the main annular portion 52m than the position P4 in the axis line CL direction. The rear end cylindrical extension portion 76 has a shape having a region in which the cross-sectional area in the radial direction surrounded by an inner circumferential surface 76i of the rear end cylindrical extension portion 76 (an inner circumferential surface of the rear end cylindrical extension portion 76 in an inner circumferential surface 70i of the back retainer 70) is the same as the cross-sectional area in the radial direction surrounded by the outer circumferential surface 30o of the cable 30 on the one side adjacent to the main annular portion 52m, and a region in which the cross-sectional area increases as it goes away from the main annular portion 52m at the rear end on the other side of the rear end cylindrical extension portion 76. For example, a cross-section of the inner circumferential surface 76i of the rear end cylindrical extension portion 76 in the radial direction is circular-shaped. An inner diameter of the rear end cylindrical extension portion 76 is constant with the diameter D2 on the one side adjacent to the main annular portion 52m and gradually increases from the diameter D2 at the rear end of the rear end cylindrical extension portion 76 as it goes away from the main annular portion 52m. The rear end cylindrical extension portion 76 corresponds to the “cylindrical extension portion” in the present invention.

Hereinafter, the back retainer 70 after being press-fitted will be described based on a state where the cable 30 and the back retainer 70 are installed into the connector body 20, as illustrated on the left side of FIG. 4.

The cable 30 and the back retainer 70 are installed into the connector body 20 in the same manner as in the above-described first embodiment. First, after the cable 30 having the front end to which the terminal fitting 32 is crimped is interpolated from the opening on the other side of the cylindrical portion 22, the rubber stopper 40 is press-fitted from the opening of the cylindrical portion 22 into the inside of the cylindrical portion 22 while holding the cable 30 on the inner circumferential side thereof. Then, after the rubber stopper 40 is press-fitted, the back retainer 70 is press-fitted from the opening of the cylindrical portion 22 into the inside of the cylindrical portion 22 while holding the cable 30 on the inner circumferential side thereof. The back retainer 70 is press-fitted such that the rear end cylindrical extension portion 74 faces the rubber stopper 40. By press-fitting the back retainer 70, the engaging protrusion 74s is engaged with the engaging hole 22s, such that the back retainer 70 is prevented from detaching from the cylindrical portion 22 and the back retainer 70 is fixed between the inner circumferential surface 22i of the cylindrical portion 22 and the outer circumferential surface 30o of the cable 30. The back retainer 70 is arranged on the other side as compared with the rubber stopper 40. As such, the one side of the rubber stopper 40 abuts on the other side of the pressing portion 24 and the other side of the rubber stopper 40 abuts on the one side of the back retainer 70, such that the rubber stopper 40 is restricted from moving to any of the one side and the other side.

The press-fitted back retainer 70 is in a state of being compressed in the radial direction by the cylindrical portion 22. Specifically, the main annular portion 52m is compressed such that the outer diameter thereof becomes the diameter D1. The front end cylindrical extension portion 74 includes a region in which the outer circumferential surface 74o of the front end cylindrical extension portion 74 does not abut on the inner circumferential surface 22i of the cylindrical portion 22 and the inner circumferential surface 74i of the front end cylindrical extension portion 74 abuts on the outer circumferential surface 30o of the cable 30 (the region between the position P0 and the position P1). Further, a region where the outer diameter is greater than the diameter D1 (the region between the position P2 and the position P3 in the axis line CL direction) in the rear end cylindrical extension portion 76 is also compressed such that the outer diameter thereof becomes the diameter D1. The compression amount on the main annular portion 52m in the radial direction is in a state where the compression amount gradually increases as it goes from the position P1 (the one side) to the position P2 (the other side). The compression amount on the rear end cylindrical extension portion 76 in the radial direction gradually decreases as it goes from the position P2 (the one side) to the position P3 (the other side). The rear end cylindrical extension portion 76 includes a region in which the outer circumferential surface 76o of the rear end cylindrical extension portion 76 does not abut on the inner circumferential surface 22i of the cylindrical portion 22 and the inner circumference surface 76i of the rear end cylindrical extension portion 76 abuts on the outer circumferential surface 30o of the cable 30 (the region between the position P4 and the position P5).

By compressing the main annular portion 52m in the cylindrical portion 22 in the radial direction, a region on the other side adjacent to the main annular portion 52m in the front end cylindrical extension portion 74 (a region in which the outer circumferential surface 74o does not abut on the inner circumferential surface 22i and the inner circumferential surface 74i abuts on the outer circumferential surface 30o) is also in the compressed state in the radial direction. Therefore, a pressing force from the back retainer 70 side toward the cable 30 is generated in the region on the other side adjacent to the main annular portion 52m in the front end cylindrical extension portion 74 together with the main annular portion 52m on an abutting surface between the inner circumferential surface 70i of the back retainer 70 and the outer circumferential surface 30o of the cable 30. The compression amount in the radial direction on the back retainer 70 is in a state where the compression amount gradually decreases as it goes from the position P1 toward the one side.

Similarly, the pressing force from the back retainer 70 side toward the cable 30 is generated in a region on the one side adjacent to the main annular portion 52m in the rear end cylindrical extension portion 76 together with the main annular portion 52m (a region in which the outer circumferential surface 76o does not abut on the inner circumferential surface 22i and the inner circumferential surface 76i abuts on the outer circumferential surface 30o) on the abutting surface between the inner circumferential surface 70i of the back retainer 70 and the outer circumferential surface 30o of the cable 30. The compression amount in the radial direction on the back retainer 70 is in a state where the compression amount gradually decreases as it goes from the position P2 toward the other side.

With the present embodiment, since the back retainer 70 includes the same configuration as the main annular portion 52m in the above-described first embodiment, the same effect as that of the above-described first embodiment based on the main annular portion 52m is achieved.

With the present embodiment, (a) the back retainer 70 includes the front end cylindrical extension portion 74 extending from the main annular portion 52m to the one side in the axis line CL direction and the rear end cylindrical extension portion 76 extending from the main annular portion 52m to the other side in the axis line CL direction, (b) the front end cylindrical extension portion 74 includes the region in which the outer circumferential surface 74o of the front end cylindrical extension portion 74 does not abut on the inner circumferential surface 22i of the cylindrical portion 22 and the inner circumferential surface 74i of the front end cylindrical extension portion 74 abuts on the outer circumferential surface 30o of the cable 30, and (c) the rear end cylindrical extension portion 76 includes the region in which the outer circumferential surface 76o of the rear end cylindrical extension portion 76 does not abut on the inner circumferential surface 22i of the cylindrical portion 22 and the inner circumferential surface 76i of the rear end cylindrical extension portion 76 abuts on the outer circumferential surface 30o of the cable 30. By providing the back retainer 70 with the front end cylindrical extension portion 74 and the rear end cylindrical extension portion 76, a pressing force from the back retainer 70 side toward the cable 30 is generated in the front end cylindrical extension portion 74 and the rear end cylindrical extension portion 76 together with the main annular portion 52m on the abutting surface between the inner circumferential surface 70i of the back retainer 70 and the outer circumferential surface 30o of the cable 30. As such, a holding force for holding the cable 30 in the connector body 20 via the back retainer 70 is enhanced as compared with a case where neither the front end cylindrical extension portion 74 nor the rear end cylindrical extension portion 76 is provided. Therefore, when the cable 30 extending to the outside of the connector body 20 vibrates due to an external force or the like, the vibration on the abutting surface is further prevented such that a reduction in connection strength of the crimping portion 34, which is a crimping part between the cable 30 and the terminal fitting 32, is further prevented. As a result, a reduction in the reliability of connection at the crimping portion 34 inside the connector 10 is further prevented.

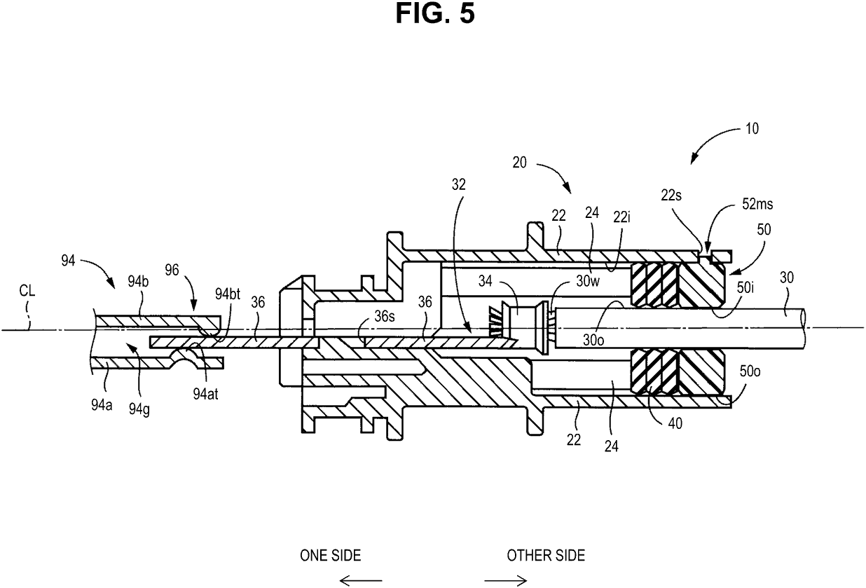

FIG. 5 is a cross-sectional view of an installation structure of the cable 30 into the connector 10 according to a fourth embodiment of the present invention. Unlike the above-described first, second, and third embodiments in which the bus bar connected to the winding of the stator of the rotating machine, which is the driving source for traveling, and the terminal portion 36 are fastened by the fastening member 98, in the present embodiment, they are electrically connected using a spring contact structure 96. In the present embodiment, a case where the spring contact structure 96 is applied to the first embodiment will be described as a representative, but the spring contact structure 96 can also be applied to the second and third embodiments.

In the spring contact structure 96, the one side of the bus bar 94 in the axis line CL direction is connected to and fixed to the winding of the stator. The other side of the bus bar 94 in the axis line CL direction has, for example, a pair of plate-shaped portions 94a, 94b extending to the other side. A gap 94g into which the terminal portion 36 of the terminal fitting 32 can be inserted is provided between the plate-shaped portions 94a, 94b in the thickness direction thereof. The plate-shaped portions 94a, 94b are respectively provided with protrusions 94at, 94bt protruding toward the gap 94g side. When the terminal portion 36 is inserted into the gap 94g, the plate-shaped portions 94a, 94b sandwich the terminal portion 36 by a biasing force of the plate-shaped portions 94a, 94b (the biasing force by the spring), such that the protrusions 94at, 94bt of the bus bar 94 respectively come into contact with both sides of the terminal portion 36. As such, the bus bar 94 and the terminal portion 36 are in the electrically connected state.

With the present embodiment, since the connector body 20 and the back retainer 50 have the same configurations as those in the above-described first embodiment, even when the cable 30 extending to the outside of the connector body 20 vibrates due to an external force or the like, the vibration on the abutting surface between the inner circumferential surface 50i of the back retainer 50 and the outer circumferential surface 30o of the cable 30 is prevented. Therefore, the vibration of the cable 30 is prevented from being transferred to the spring contact structure 96, that is, the vibration of the cable 30 extending to the outside of the connector body 20 is prevented from being transferred to a contacting portion between the protrusion 94at and the terminal portion 36 or a contacting portion between the protrusion 94bt and the terminal portion 36 in the spring contact structure 96. Therefore, the contacting portion between the protrusion 94at and the terminal portion 36 and the contacting portion between the protrusion 94bt and the terminal portion 36 are prevented from being worn by transferred vibration. As such, by preventing the wearing, a reduction in the reliability of connection at the spring contact structure 96 inside the connector 10 is prevented. Similarly, when the spring contact structure 96 is applied to the second and third embodiments, by preventing the wearing of the spring contact structure 96, a reduction in the reliability of connection at the spring contact structure 96 inside the connector 10 is also prevented.

### Related Art

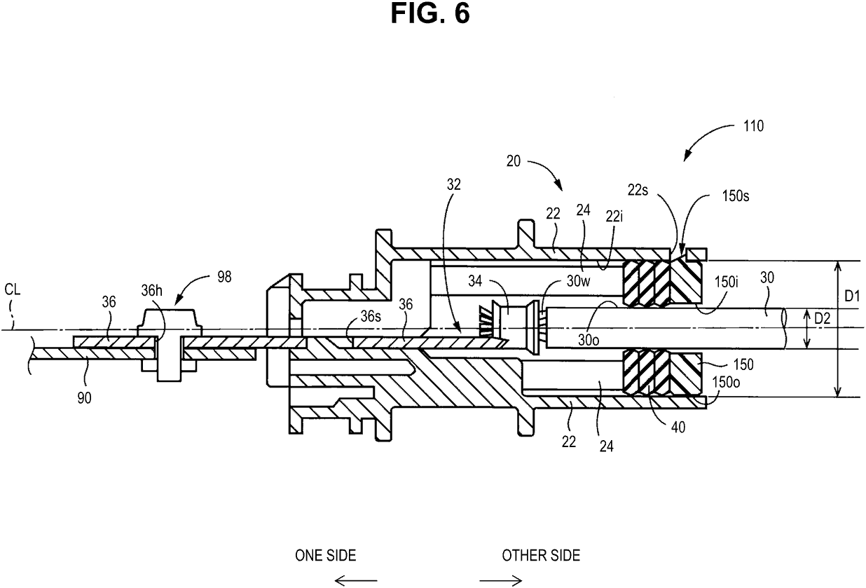

Hereinafter, the related art will be described for comparison with the embodiments according to the present invention. FIG. 6 is a cross-sectional view of the installation structure of the cable 30 into a connector 110 in the related art. The installation structure in the related art has substantially the same configuration as that of the first embodiment, except that a back retainer 150 is used instead of the back retainer 50 in the first embodiment. FIG. 6 is the cross-sectional view illustrating a state in which the cable 30 is installed into the connector body 20 and includes the axis line CL of the cylindrical portion 22 of the connector body 20, which will be described below.

The connector 110 includes the connector body 20, the cable 30, the terminal fitting 32, the rubber stopper 40, and the back retainer 150.

A shape of the back retainer 150 before and after the cable 30 and the back retainer 150 are installed into the connector body 20 is the same as that after the installation. An inner diameter of the back retainer 150 is slightly greater than the diameter D2.

An outer circumferential surface 150o of the back retainer 150 is provided with a plurality of engaging protrusions 150s protruding in the radial direction as compared with the diameter D1 at, for example, every predetermined equiangular interval (for example, every 2π/3 [rad]) in the circumferential direction so that the engaging protrusions 150s can be engaged with the engaging holes 22s provided on the cylindrical portion 22. On the other side of the rubber stopper 40 (between the rubber stopper 40 and the opening of the cylindrical portion 22) in the axis line CL direction, the back retainer 150 is interpolated between the inner circumferential surface 22i of the cylindrical portion 22 and the outer circumferential surface 30o of the cable 30. The back retainer 150 is fixed inside the cylindrical portion 22 by engaging the engaging protrusions 150s with the corresponding engaging holes 22s, respectively. As such, the rubber stopper 40 is restricted from moving to the other side.

The back retainer 150 in the related art is provided so as to prevent the rubber stopper 40 from detaching from the cylindrical portion 22, and an inner circumferential surface 150i of the back retainer 150 and the outer circumferential surface 30o of the cable 30 do not abut with each other. As such, since they do not abut with each other, the cable 30 is not held in the connector body 20 via the back retainer 150.

For this reason, in the related art, when the cable 30 extending to the outside of the connector body 20 vibrates, for example, in the radial direction, due to an external force (for example, vehicle vibration) or the like, the rubber stopper 40 is elastically deformed in the direction of the vibration. As such, due to the elastic deformation of the rubber stopper 40, the vibration may be transferred to the crimping portion 34, which is the crimping part between the cable 30 and the terminal fitting 32, and thus connection strength of the crimping portion 34 may reduce. Further, in the related art, as in the above-described fourth embodiment, when the bus bar 90 connected to the winding of the stator of the rotating machine, which is the driving source for traveling, is electrically connected to the terminal portion 36 via the spring contact structure 96, the vibration of the cable 30 is transferred to the spring contact structure 96. As such, the contacting portion between the protrusion 94at and the terminal portion 36 and the contacting portion between the protrusion 94bt and the terminal portion 36 in the spring contact structure 96 may be worn by transferred vibration, and thus the reliability of connection at the spring contact structure 96 inside the connector 10 may reduce.

As above, the embodiments of the present invention have been described in detail with reference to the drawings, but the present invention is also applied to other aspects.

In the above-described first, second, third, and fourth embodiments, the cable 30 having the front end to which the terminal fitting 32 is crimped is interpolated in the cylindrical portions 22, 28, but the present invention is not limited thereto. For example, the cable 30 may be interpolated in a cylindrical portion having a cross-section in the radial direction of the inner circumferential surface which is ellipse-shaped and extending in a straight line direction.

In the above-described first, second, third, and fourth embodiments, each of the rubber stopper 40 and the back retainers 50, 60, 70 has an annular shape in which one of three cables 30 that supply the three-phase alternate current power for rotation drive to the three-phase synchronous rotor is interposed on the inner circumferential side thereof, but the present invention is not limited thereto. For example, when the above-described three cables 30 are interpolated at every predetermined interval in a single cylindrical portion having a cross-section in the radial direction of the inner circumferential surface which is ellipse-shaped and each included in the connector bodies 20, 26, the back retainers 50, 60, 70 do not have to be annular as long as they have a shape that allows them to abut on the inner circumferential surface of the cylindrical portion and each of the outer circumferential surfaces 30o of the above-described three cables 30. Specifically, in the first, second, and third embodiments, the three back retainers 50, 60, 70 may be connected at the predetermined intervals. Similarly, the shape of the rubber stopper 40 is not limited to the annular shape.

In the above-described first, second, third, and fourth embodiments, in the cross-section including the axis line CL, the outer circumferential surfaces 52mo, 62mo of the main annular portions 52m, 62m before being press-fitted are inclined with respect to the axis line CL at the constant angles α1, α2, but the present invention is not limited to the above aspects. For example, in the cross-section including the axis line CL, the inclinations of the outer circumferential surfaces 52mo, 62mo of the main annular portions 52m, 62m are not limited to the constant angles with respect to the axis line CL. The inclinations may have any angle as long as there is no step that discontinuously increases resistance which the main annular portions 52m, 62m receive from the cylindrical portions 22, 28 when the main annular portions 52m, 62m are press-fitted between the inner circumferential surfaces 22i, 28i of the cylindrical portions 22, 28 and the outer circumferential surface 30o of the cable 30.

In the above-described first, second, and fourth embodiments, the back retainers 50, 60 are not provided with the front end cylindrical extension portion 74 and the rear end cylindrical extension portion 76 as in the third embodiment, but may be provided. Further, the back retainers 50, 60, 70 may be provided with at least one of the front end cylindrical extension portion 74 and the rear end cylindrical extension portion 76. Even when only one of the front end cylindrical extension portion 74 and the rear end cylindrical extension portion 76 is provided, a holding force for holding the cable 30 in the connector bodies 20, 26 via the back retainers 50, 60, 70 is enhanced as compared with a case where neither the front end cylindrical extension portion 74 nor the rear end cylindrical extension portion 76 is provided. Therefore, a reduction in connection strength of the crimping portion 34, which is the crimping portion between the cable 30 and the terminal fitting 32, is prevented.

In the above-described first, second, third, and fourth embodiments, the engaging holes 22s, 28s provided in the cylindrical portions 22, 28 of the connector bodies 20, 26 respectively penetrate the cylindrical portions 22, 28 in the radial direction. However, the holes do not have to penetrate the cylindrical portions 22, 28 as long as the back retainers 50, 60, 70 can be prevented from detaching from the cylindrical portions 22, 28. Further, as illustrated in the third embodiment, the engaging protrusion 74s does not have to be provided on the outer circumferential surface 52mo of the main annular portion 52m, and may be provided on any part of the outer circumferential surfaces 50o, 60o, 70o of the back retainers 50, 60, 70.

In the above-described first, second, third, and fourth embodiments, the cylindrical portions 22, 28 of the connector bodies 20, 26 are provided with the engaging holes 22s, 28s, and the back retainers 50, 60, 70 are provided with the engaging protrusions 52ms, 62ms, 74s as retaining portions, but the present invention is not limited thereto. For example, the inner circumferential surfaces 22i, 28i of the cylindrical portions 22, 28 may be provided with engaging protrusions protruding in the radial direction toward the inner circumferential side, and the outer circumferential surfaces 50o, 60o, 70o of the back retainers 50, 60, 70 may be provided with engaging holes as retaining portions so as to be engaged with the engaging protrusions.

In the above-described first, second, third, and fourth embodiments, the other side of the rubber stopper 40 and the one side of the back retainers 50, 60, 70 abut with each other, but they do not necessarily have to abut with each other as long as the rubber stopper 40 can be prevented from detaching from the cylindrical portion 22. Similarly, the one side of the rubber stopper 40 and the other side of the pressing portion 24 do not necessarily have to abut with each other.

The above descriptions are merely embodiments of the present invention, and the present invention can be executed in an aspect in which various changes and improvements are made based on knowledge of those skilled in the art within a range not departing from the scope thereof.

What is claimed is:

1. An installation structure of an electric wire into a connector, the installation structure comprising:
a connector body including a cylindrical portion that extends in one direction;
an electric wire of which a front end on one side in the one direction is connected to a terminal fitting and the front end is interpolated in the connector body;
a sealing member that abuts on an inner circumferential surface of the cylindrical portion and an outer circumferential surface of the electric wire; and
a back retainer arranged between the inner circumferential surface of the cylindrical portion and the outer circumferential surface of the electric wire, on an opposite side to a side of the front end ahead of the sealing member, wherein:
the back retainer is arranged in a compressed state between the inner circumferential surface of the cylindrical portion and the outer circumferential surface of the electric wire;
the back retainer includes a compression portion which is configured such that a compression amount on the back retainer in a radial direction of the cylindrical portion that extends in the one direction gradually increases as the compression amount goes from the side of the front end toward the opposite side; and
the back retainer includes a retaining portion configured to prevent the back retainer from detaching from the cylindrical portion on an outer circumferential surface of the back retainer.

2. The installation structure according to claim 1, wherein, in a cross-section along the one direction, an outer circumferential surface of the compression portion before being press-fitted has an inclination greater than an inclination of the inner circumferential surface of the cylindrical portion corresponding to a position at which the compression portion is press-fitted.

3. The installation structure according to claim 1, wherein the retaining portion is arranged on an outer circumferential surface of the compression portion.

4. The installation structure according to claim 1 , wherein the retaining portion is an engaging protrusion protruding in the radial direction from the outer circumferential surface of the back retainer such that the retaining portion is engaged with an engaging hole formed in the cylindrical portion and penetrating the cylindrical portion in the radial direction.

5. The installation structure according to claim 1, wherein:
the back retainer includes a cylindrical extension portion extending from the compression portion to at least one of the side of the front end and the opposite side in the one direction; and
the cylindrical extension portion includes a region in which an outer circumferential surface of the cylindrical extension portion does not abut on the inner circumferential surface of the cylindrical portion and an inner circumferential surface of the cylindrical extension portion abuts on the outer circumferential surface of the electric wire.
